(19) United States
(12) Patent Application Publication
(10) Pub. No.: US 2012/0173320 A1
(43) Pub. Date: Jul. 5, 2012

(54) Method and system for facilitating commerce, social interaction and charitable activities

(75) Inventors: Kevin J. Kail, Great Falls, VA (US); Jason Kummeri, Warren, MI (US); David M. Russell, Lutz, FL (US)

(73) Assignee: epcSolutions, Inc.

(21) Appl. No.: 13/374,648

(22) Filed: Jan. 5, 2012

Related U.S. Application Data
(60) Provisional application No. 61/457,119, filed on Jan. 5, 2011.

(51) Int. Cl. G06Q 30/02

(52) U.S. Cl. 705/14.4; 705/26.1

(57) ABSTRACT

A method for automating commerce, including the work of selling, shopping for, and/or selling goods and services; by facilitating communications between any combination of buyers and sellers to facilitate opportunities for commercial activities. The method also includes facilitating opportunities for related activities, for example, charitable activities, in a manner that maximizes efficiencies including reducing intermediaries between consumers and manufacturers.

### RELATED APPLICATIONS

The present application is related to and claims priority from U.S. Provisional Patent Application No. 61/457,119 filed Jan. 5, 2012.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### FIELD OF THE INVENTION

The present invention relates to methods and systems for automating commerce, including the work of selling, shopping for, and/or selling goods and services; facilitating communications between any combination of buyers and sellers; facilitating opportunities for commercial activities; facilitating opportunities for related activities, for example, charitable activities, in a manner that maximizes efficiencies including reducing intermediaries between consumers and manufacturers.

### BACKGROUND OF THE INVENTION

In this age of ubiquitous Internet and similar communications network access, online communities, and online retailing, methods are needed to seamlessly integrate these disparate functionalities. Ideally, such methods and the apparatuses embodied therein will both enhance the user experience while simultaneously facilitating an increased flow of information that will be useful to manufacturers, retailers, and other parties in the supply chain.

The advent of the Internet-age and its unprecedented access to information is transforming society in heretofore unimagined ways. E-mail is quickly making the U.S. Postal Service and its so-called “snail mail” a relic of previous generations. Similarly, Facebook®, Twitter®, LinkedIn®, MySpace® and other social networking services are changing the way people communicate, combining the real-time aspects of traditional telephony through their chat and SMS features with so-called “push” functionality in the form of their status update features, in addition offering legacy e-mail-like functionalities for those still needing this feature. Retailers have been quick to recognize that these social networks are a potential treasure trove of customers. Customers, in turn, are leveraging their nearly instant and ubiquitous access to information to comparison shop, post their opinions about particular items, retailers, or manufacturers, or otherwise inform themselves and others with regard to goods or services. Customers are now better-able to identify the best product for their needs and in addition are quickly able to determine where the product can be had at the best price. With particular regard to comparison shopping, the ever increasing popularity of so-called “smart” mobile telephones and similar handheld devices, services like RedLaser® now permit customers to comparison shop online and at local retailers simply by photographing/scanning an item barcode using the camera built into the device.

While these services are well-known, there is a need to better integrate them. For example, Twitter® followers of a particular retailer may be rewarded with a discount or coupon and the recent phenomenon of so-called “haul” videos on YouTube® and similar sites attest to consumers' desire to tell their friends and others about their recent purchases However, at present, retailers and manufacturers are unable to discern the voluminous data freely available from these customers, for example their demographic information or location, or similar products they already own, which when appropriately mined can yield invaluable data facilitating better marketing of their products and/or customer driven improvements or modifications

### SUMMARY OF THE INVENTION

The present invention leverages the availability of Internet-enabled (or other communications network-enabled) mobile telephones and similar handheld devices having built-in cameras to thereby facilitate synergistic interaction between users, their peers, manufacturers, and other parties participating in the retail chain of goods using Global Data Synchronization Network (GDSN) data associated with barcode information captured using the aforementioned cameras. It is additionally contemplated that devices capable of scanning an RFID tag may be used in lieu of a barcode scan. Geospatial information from the mobile handset GPS receiver may be further used to correlate consumers and their buying habits with retailers and manufacturers to facilitate mutually beneficial interactions thereby permitting retailers and manufacturers to better target their customers while concurrently empowering customers with the information necessary for making a more informed decision regarding their purchasing choices. Moreover, the heretofore unprecedented interaction between retailer, manufacturers, consumers, and the like can facilitate a charitable component whereby consumers may elect to, for example, leverage their purchases individually or collectively to benefit charitable organizations. Similarly, charitable organizations may be able to leverage this new level of interactivity to incent donations to their causes.

It is an object of this invention to facilitate consumer access to information regarding retail goods, services, and the like;

It is yet another object of this invention to facilitate consumer access to coupons and discounts with regard to retail goods, services, and the like;

It is still another object of this invention to provide retailers, manufacturers, and the like with information regarding customers and potential customers;

It is further an object of this invention to facilitate synergistic interaction between consumers, retailers, manufacturers, and the like;

It is an additional object of this invention to facilitate charitable activity;

It is also an object of this invention to incentivize increased charitable activity;

It is yet another object of this invention to facilitate tiered reward structures for saving and charitable activity;

It is still another object of this invention to engage, entertain, and inform users/customers;

It is another object of this invention to engage retailers and manufacturers into a cooperative venture;

It is a further object of this invention to facilitate precise tracking of customer purchasing patterns including their geospatial information; and,

It is also an object of this invention to create socially interactive communities having an affinity to particular products.

These and other objects, advantages, and novel features of the present invention will become apparent when considered with the teachings contained in the detailed description, claims, and accompanying drawings.

### BRIEF DESCRIPTION OF THE DRAWINGS

FIG. 1 is a diagrammatic representation of the invention;

FIG. 2 is a flow diagram showing the retrieval of merchandise information using barcode information;

FIG. 3 is a flow diagram showing a method regarding product information queries;

FIG. 4 is a flow diagram showing a method by which data is updated;

FIG. 5 is a flow diagram showing a method for retrieving product information;

FIG. 6 is a flow diagram showing a method for communicating product information;

FIG. 7 is a flow diagram showing a method of using affinity information within a social network;

FIG. 8 is a flow diagram showing a method of sharing affinity information within a social network;

FIG. 9 is a flow diagram showing a method of triggering rewards; and,

FIG. 10 is a flow diagram showing a method to facilitate charitable activities.

### DETAILED DESCRIPTION OF THE INVENTION

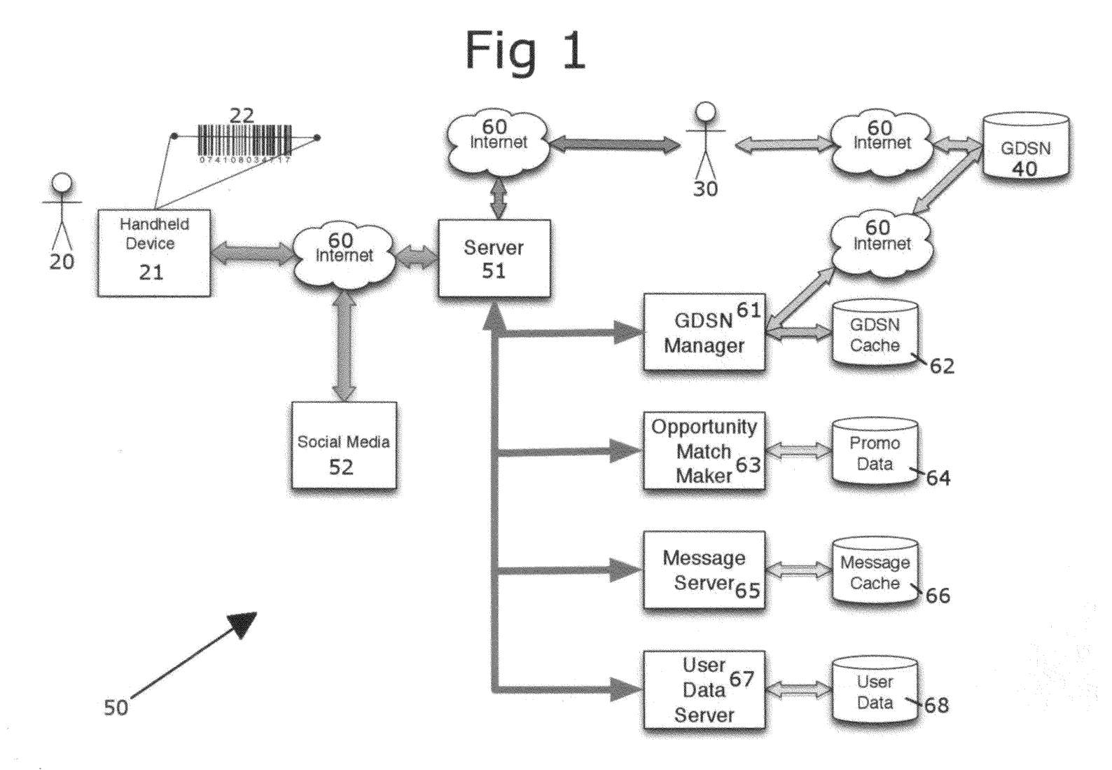

The preferred embodiment and best mode of the invention are shown in FIGS. 1 through 10. While the invention herein is described with regard to certain preferred embodiments, it is not intended that the present invention be so limited. On the contrary, it is intended to cover all alternatives, modifications, and equivalent arrangements as may be included within the spirit and scope of the invention as defined by the subsequent claims.

In accordance with the invention, FIG. 1 shows a diagrammatic overview of the present invention whereby a user/consumer 20 initiates the process by scanning a specific merchandise barcode 22 with a handheld device 21. Thereafter, the user/consumer 20 and retailer/manufacturer 30 interact via the following method of the present invention. The method 50 is generally Internet 60 enabled whereby a server 51 mediates interactions between a user/consumer 20 utilizing his/her handheld device 21 and a retailer/manufacturer 30 via social media 52, for example, Facebook®, Twitter®, LinkedIn®, MySpace®, and the like. The server 51 is additionally in communication with a GDSN manager 61 with concomitant GDSN cache 62, which is itself in communication with the GDSN 40. The server 51 is also in communication with an opportunity matchmaker 63 which accesses promotional data 64, for example data pertaining to coupons, bundles, specials, specific locations, manufacturer/retailer benefactors of particular charitable organizations, donation tallies, and the like, in order to enhance interactivity according to an algorithm of the claimed inventive method 50. Additionally, the server 51 is in communication with a message server 65 in communication with a message cache 66 facilitating temporary storage of messages until they are received by the user/consumer 20 is included. Server 51 further comprises and is in communication with a user data server 67 which is itself in communication with a volume(s) containing user data 68, for example, histories of products already scanned, general account data, preference settings, awards, and friend links and data. The user data server 67 and user data volume(s) 68 generally include information regarding, for example, matching consumers to merchandise or merchandising opportunities or the like. The user data server 67 and user data volume(s) 68 may match products according to previous user/consumer 20 product queries, user/consumer 20 scanning of barcodes (or RFID tags), product reviews created by the user/consumer 20, product reviews by user/consumer 20 friends (as mediated by social media 52), user/consumer 20 purchase history, user/consumer 20 gifting history, user/consumer 20 wish lists, and the like. The message server 65 in communication with a message cache 66 facilitates temporary storage of messages until they are received by the user/consumer 20.

The inventive system 50 described herein facilitates interaction between the user/consumer 20 and retailer/manufacturer 30. The user/consumer 20 barcode or alternatively, an RFID tag scans may be used to generate buying habits for particular users or be used in aggregate to generate purchasing trends for particular locales or demographics. Thus, real-time, extremely accurate sales information can be generated. For example, coupons for brand X may be generated when the system 50 detects that the user/consumer 20 has scanned brand Y. Similarly, detecting that the user/consumer is a videophile, audiophile, etc. may indicate he/she is particularly likely to buy a nascent technology and is accordingly sent a coupon. In yet another example, the user/consumer 20 may scan an item at a particular retailer and receive a coupon, usable only at that retailer for the item scanned or a competing item if the manufacturers' information database confirms competitive rebate coupons to meet competitor prices.

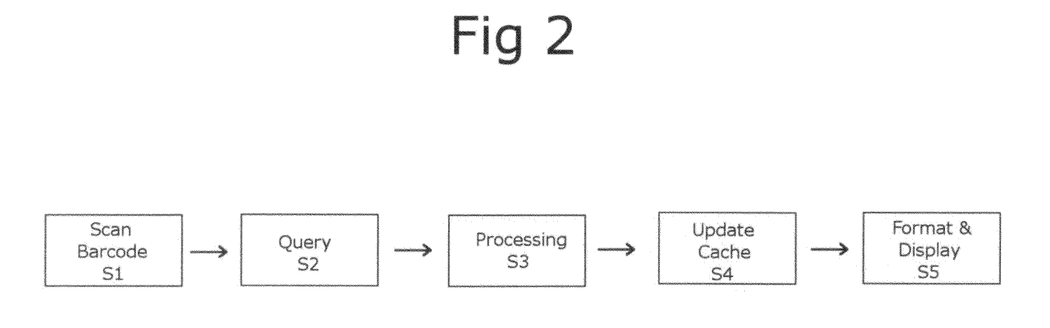

Turning now to FIG. 2, a flow chart is shown with regard to retrieving merchandise information in conjunction with a barcode (or RFID tag) scan according to the present invention. In an acquisition step S 1, the user/consumer 20 scans the barcode (or RFID tag) of a product using his/her handheld device 21 (not shown). Thereafter, in a query step S2, the application of the present method 50 communicates data, including device identification and location, information broadcast by other nearby wireless devices, and the like to server 51 (not shown). In step S3, the server 51 (not shown) processes the query and triggers additional queries according to an algorithm whereby information is retrieved, including data supplied by the manufacturer to the GDSN with regard to their product, links to additional product information or reviews, product reviews by third parties, competing product information, coupons or other promotions, and messages from friends, manufacturers/retailers, or service providers. Thereafter, the handheld application updates the local cache S4 on the handheld device 21 (not shown) and the resulting information is appropriately formatted for display S5 on the device 21 (not shown) as desired by the user/consumer 20 (not shown).

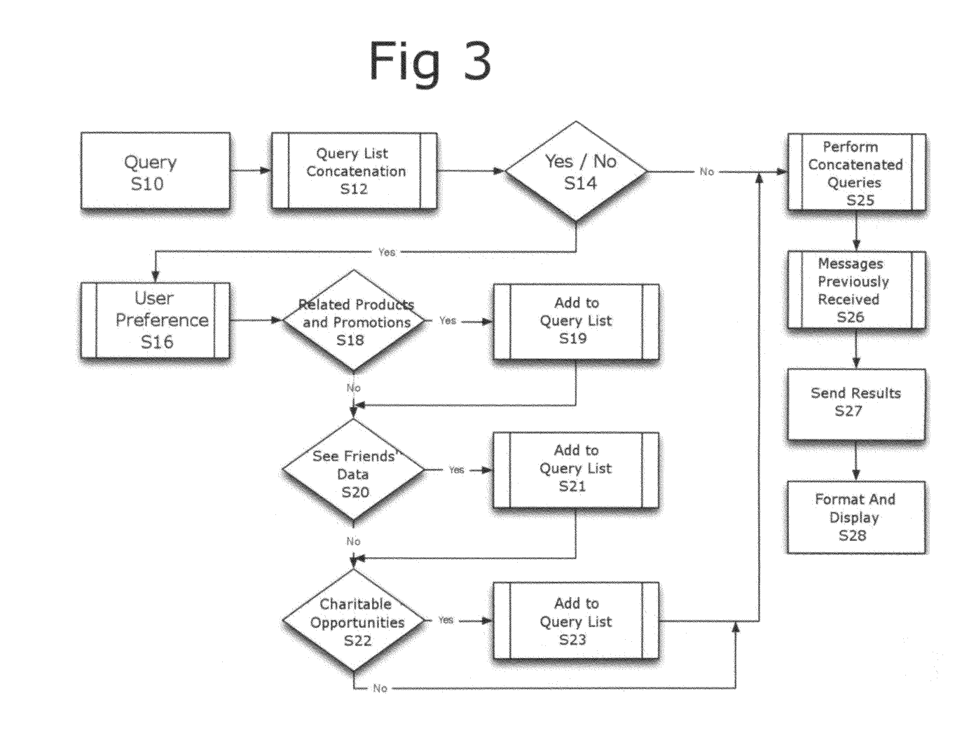

FIG. 3 shows in detail a preferred method in which a query may be performed using the handheld device 21 (not shown) with regard to ascertaining product information. Accordingly, in a first step, S10, a query with regard to product information or a friend's information is initiated to the server 51 (not shown) whereby a list of queries is generated S12. At yes/no gate S14, queries related to product information commence to a user preference step S16 whereby the users preferences for: receiving information pertaining to related products and promotions S18, seeing friends' data S20, and available charitable opportunities S22 are determined and included in the query list as required S19, S21, S23. Thereafter, the list of queries is performed S25, and any messages waiting for the user/consumer 20 (not shown) are added to the results S26. Subsequently, the server 51 (not shown) sends the results S27 to the handheld application on the handheld device 21 (not shown) and the resulting information is appropriately formatted for display S28 on the device 21 (not shown) as desired by the user/consumer 20 (not shown). Note that a negative at yes/no gate S14 bypasses steps S16-S23 such that the present list of queries is performed immediately at S25.

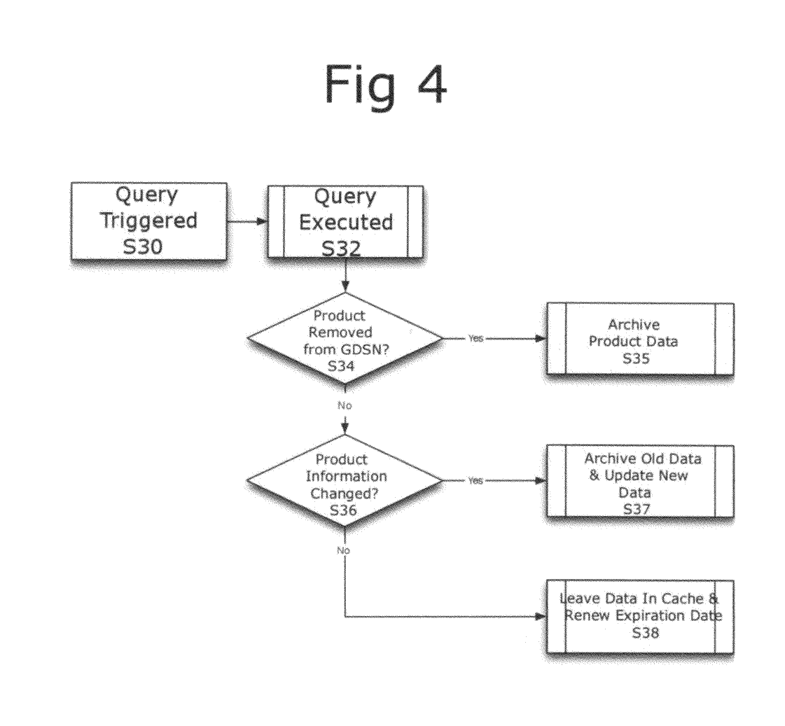

FIG. 4 shows in detail a preferred method regarding maintaining up-to-date data with respect to the present invention wherein a new query is triggered S30, then executed S32 at the expiration of the GDSN data in its cache. In instances where the item has been removed from the GDSN S34, product data is archived S35. In instances where the item has not been removed from the GDSN, a determination is made whether the item information has changed S36. If the item information has changed, the previous item information is archived S37 and where there is no change in product information, the data is left in the cache unchanged S38 and the expiration period is renewed.

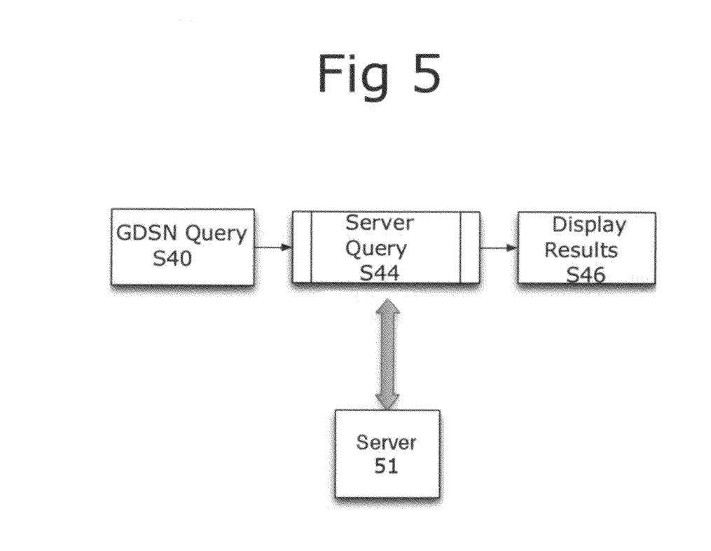

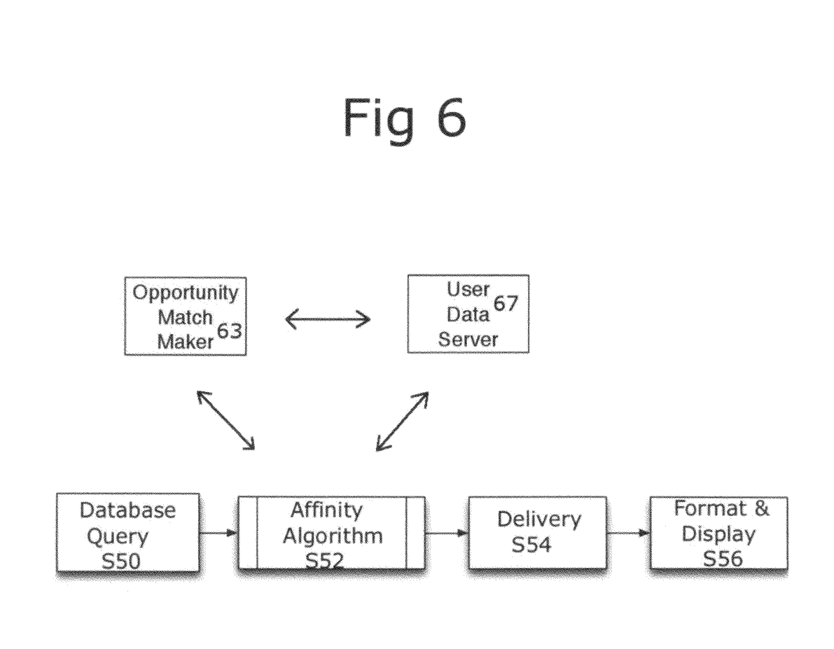

FIGS. 5 and 6 show methods whereby product information may be retrieved (FIG. 5) and communicated (FIG. 6) via a handheld device, typically a mobile handset. In FIG. 5, the user/consumer 20 (not shown) initiates a GDSN query S40 regarding a product via the server 51 (not shown) of the present invention. The query may be manually input, for example, by scanning a barcode (or RFID tag) using the handset or manually entering a barcode using the handset keyboard. Thereafter, the server 51 is queried S44 to determine, for example, coupon availability, promotional opportunities, or similar special offers. In a preferred embodiment, the query S44 includes information regarding the user and device from which the query is initiated. The query may include device identifying information, for example, an International Mobile Equipment Identity (IMEI) number, an Electronic Serial Number (ESN), Mobile Equipment Identifier (MEID), Pseudo Electronic Serial Number (pESN), a Media Access Control (MAC) address, or the like, device location information, information broadcast by nearby wireless devices, and any other data perceivable by device sensors and circuits. Thereafter, query results S46 are delivered to the handheld device and displayed to the user/consumer 20 (not shown). The results S46 may include promotional information, for example promotional codes for online purchases, point-of-sale (POS) coupons for use at so-called “brick and mortar” establishments, POS scannable barcodes, information or links regarding the product, information or links regarding related products, information or links regarding accessories, product reviews, information or links regarding competitor products, and the like. The promotional information may originate from GDSN data, custom information gathering, data mining activities, or other information resources. Moreover, the promotional information may be tailored according to the location of the user/consumer 20. In use, the query S40 may, for example, include results S46 specific for the particular retail establishment in which the user/consumer 20 is currently located. The results S46 may include store coupons usable only at the particular retail establishment, promotions in nearby retail establishments, promotions in establishments near locations the user/consumer 20 is known to frequent, for example, his/her home, office, or school, manufacturer's coupons, other manufacturer promotions, and the like.

Subsequent a user-initiated query as described above or similar triggering event, for example manufacturer changes to product promotions, date triggers (e.g., the day after Thanksgiving) or time triggers (e.g., typical meal hours), and myriad similar situations, for example, a manufacturer or retailer going out of business, products going out of production, auctions, news reports, and the like. FIG. 6 shows a flowchart detailing the communication of product information to the user/consumer 20. Accordingly, the aforedescribed triggering event results in a database query S50 wherein a first affinity algorithm is initiated S52 so that the opportunity matchmaker 63 and user data server 67 of the present invention operate in concert to match available promotions to a user/consumer 20 (not shown). As noted above, the query S50 may include device identifying information, for example, an International Mobile Equipment Identity (MEI) number, an Electronic Serial Number (ESN), Mobile Equipment Identifier (MEID), Pseudo Electronic Serial Number (pESN), a Media Access Control (MAC) address, or the like, device location information, information broadcast by nearby wireless devices, and any other data perceivable by device sensors and circuits. Thereafter, promotional information is delivered S54 to the handheld device and displayed S56 to the user/consumer 20 (not shown).

In practice, the first affinity algorithm of step S52 is able to match products to a particular user/consumer 20 according to, for example, previous queries, barcode scans, RFID tag scans, product reviews submitted by the user/consumer 20 or social network friends, purchase history, gifting history, wish lists, and the like. Displayed results S56 include, but are not limited to promotional information, for example promotional codes for online purchases, point-of-sale (POS) coupons for use at so-called “brick and mortar” establishments, POS scannable barcodes, information or links regarding the product, information or links regarding related products, information or links regarding accessories, product reviews, information or links regarding competitor products, and the like. The promotional information may originate from GDSN data, custom information gathering, data mining activities, or other information resources. The promotional information may additionally be tailored according to the location of the user/consumer 20 such that the displayed results S56 may be location-specific according to the user/consumer's 20 location. The displayed results S56 may include store coupons usable only at the particular retail establishment, promotions in nearby retail establishments, or promotions in establishments near locations the user/consumer 20 is known to frequent, for example, his/her home, office, or school.

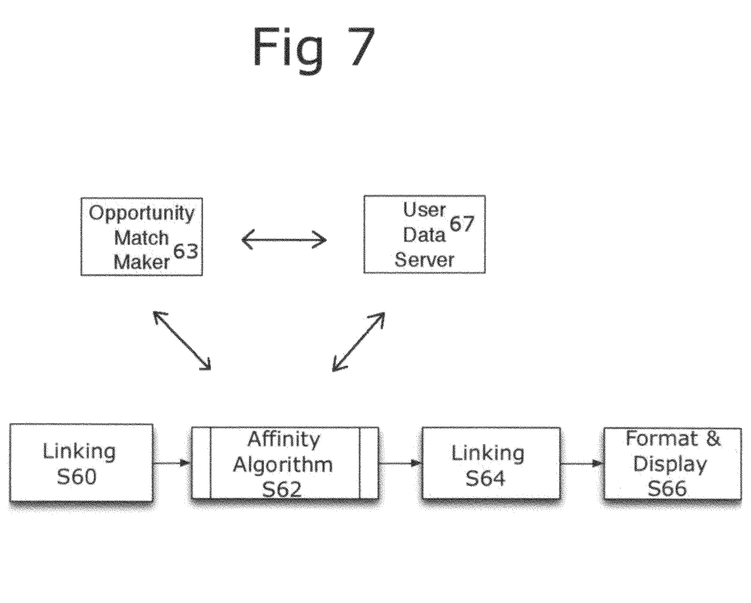

Turning now to FIG. 7, user/consumer 20 (not shown) affinity data may be accessed in combination with social media 52 (not shown), for example, Facebook®, Twitter®, LinkedIn®, MySpace®, and the like. Accordingly, the user/consumer 20 may elect to link S60 all or selected portions of their data (including referral links, embedded links, and the like) to the aforementioned social media 52 (not shown) whereby a second affinity algorithm of step S62, which may be similar or identical to the first affinity algorithm S52 (see FIG. 6), operates such that the opportunity matchmaker 63 and user data server 67 of the present invention function in concert to match available promotions to a user/consumer 20 (not shown). In step S64, the resulting specific data or links thereto are delivered to, for example, social medial 52 (not shown), or an e-mail address specified by the user/consumer 20 (not shown). The data is thereafter formatted and displayed S66.

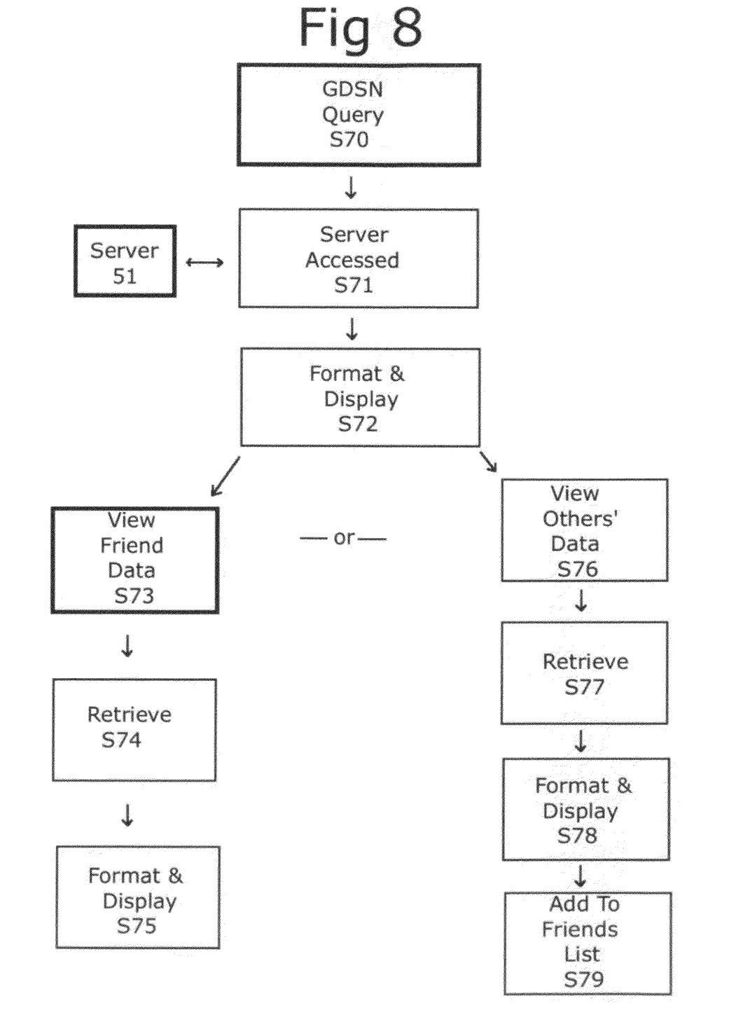

In FIG. 8, a method is disclosed whereby social media friends' or third party affinity data may be accessed. Accordingly, user/consumer 20 (not shown) initiates a GDSN query S70 regarding a product so that server 51 (not shown) is accessed in step S71 to ascertain the user/consumer's 20 (not shown) friends having data for the product or similar products. Thereafter the data is formatted and displayed for viewing S72. In instances where the user/consumer 20 (not shown) wishes to view friends' data S73, the portion of individual friends' data selected by the user/consumer 20 (not shown) is retrieved S75, then formatted and displayed for viewing S75. Alternatively, where the user/consumer 20 (not shown) wishes to view other social media users' data S76 regarding the product, the data submitted by these third parties is retrieved S77. These retrieved results may be ordered, for example according to a scoring scheme based on user feedback scores, similarity of the third party's product choices, and the like. Thereafter the data is formatted and displayed for viewing S78 and if desired, the third party is added to the user/consumer's 20 friends list S79 as mediated by each social media site's usage policies. Each process is repeated as required for accessing data for each social media friend or third party that the user/consumer 20 desires.

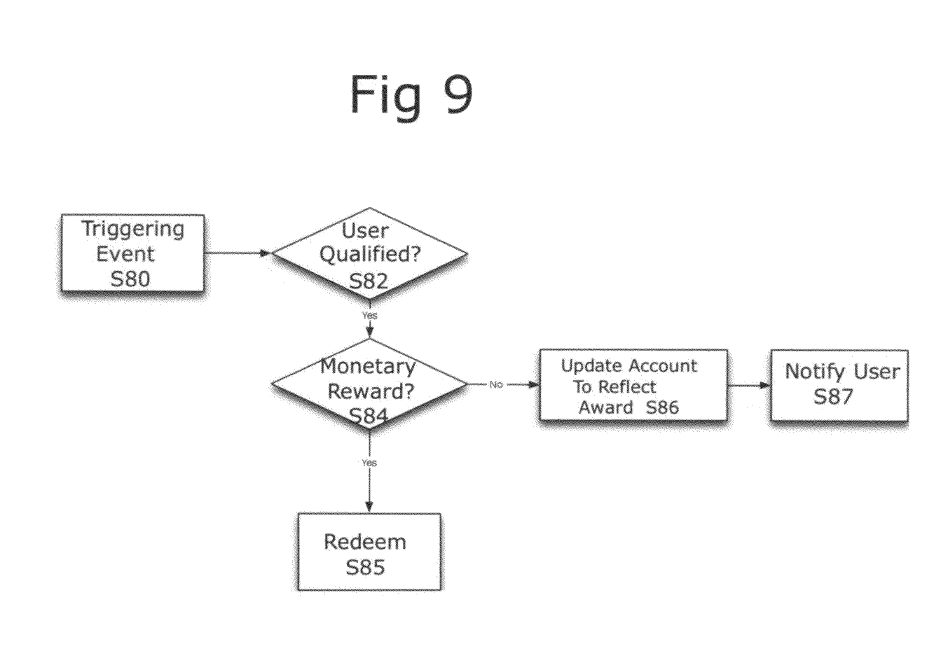

FIG. 9 discloses a method whereby rewards may be utilized to incentivize use of the system. In a first step S80, the system detects a triggering event that initiates a check against the reward system. Events may include, for example, an update to user data, scanning a barcode (or RFID tag), a change in the user's location, uploading a product review, linking to friends, a manufacturer or retailer adding a new reward or promotion, direct rewards to selected users, and the like. A determination is then made whether the user qualifies for the award S82. Qualifying can be based, for example, according to: the user's age, sex, location, or the like; the number of barcodes (or RFID tags) scanned or product reviews submitted, or the like; accumulating a predetermined number of users who have placed a product on their wishlist; random selection; or any other indicia. Thereafter, where the reward is monetary S84, a message is sent to the user with instructions for redeeming the monetary reward S85. Where the reward is non-monetary, for example, badges or points for scanning a predetermined number of products or submitting a predetermined number of reviews, or points indicating the trustworthiness of the user, the user's account is updated S86 to reflect the reward, and a message is sent to the user S87 to inform her accordingly.

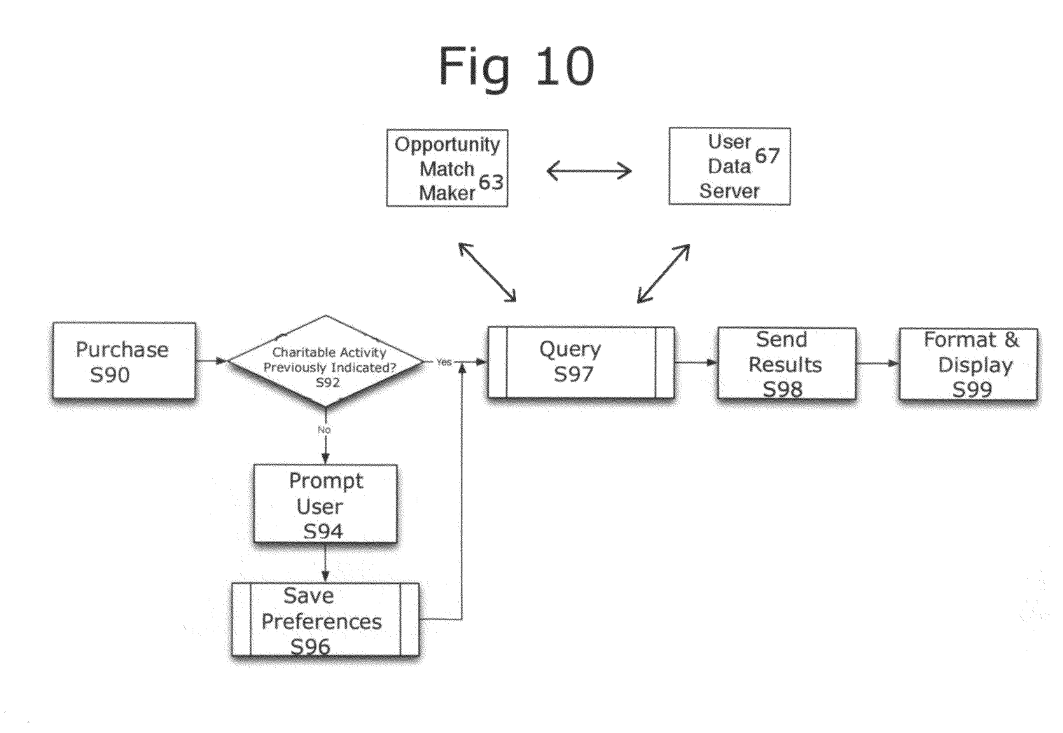

In FIG. 10, a method is disclosed whereby charitable activity may be incorporated into the system 50 of the present invention. Accordingly, in an initiation step, a user purchases (or attempts to purchase) a product S90 using the method 50 of the present invention. Thereafter, a determination is made whether the user has previously indicated a desire to engage in charitable activity S92. In instances where the user has indicated a desire to convert some or all of his/her rewards into a charitable activity S92, the system 50 prompts the user regarding what to do with the value of any discounts received S94 and the user's preference is saved S96. Where the user has elected not to participate in charitable activity S92, a database query is performed in a manner similar to those previously described wherein a third affinity algorithm is initiated S97, which may be similar or identical to the first affinity algorithm S52 (see FIG. 6), whereby the opportunity matchmaker 63 and user data server 67 of the present invention operate in concert to match available promotions to a user/consumer 20 (not shown). As above, the query S97 may include device identifying information, for example, an International Mobile Equipment Identity (IMEI) number, an Electronic Serial Number (ESN), Mobile Equipment Identifier (MEID), Pseudo Electronic Serial Number (pESN), a Media Access Control (MAC) address, or the like, device location information, information broadcast by nearby wireless devices, and any other data perceivable by device sensors and circuits. Thereafter, promotional information is delivered S98 to the handheld device and displayed S99 to the user/consumer 20 (not shown).

With particular regard to FIGS. 9 and 10, it is anticipated that awarding prizes and/or facilitating charitable activities may be a particularly effective, mutually beneficial mechanism for marketing products, goods, services, commodities, fungibles, and the like. Both strategies may leverage common competitive characteristics such that users may compete to accumulate points or other rewards (see FIG. 9) or compete with regard to sums donated to charity (see FIG. 10). With particular regard to the charitable component, suppliers may be doubly benefitted inasmuch as charitable organizations will undoubtedly market to their members products from which they receive charitable contributions.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A method for facilitating synergistic interaction between consumers, manufacturers and retailers comprising the steps of
interacting with a product using a handheld device;
accessing a manufacturer's product information database from a Global Data Synchronization Network (GDSN); and,
retrieving product information.

2. A method for facilitating synergistic interaction between consumers, manufacturers and retailers as claimed in claim 1 wherein interacting with a product using a handheld device further comprises scanning a product barcode.

3. A method for facilitating synergistic interaction between consumers, manufacturers and retailers as claimed in claim 1 wherein said handheld device is a mobile telephonic device.

4. A method for facilitating synergistic interaction between consumers, manufacturers and retailers as claimed in claim 1 further comprising the step of:
retrieving an item selected from the group consisting of a coupon, an electronic coupon, a printable coupon, a discount code, and discount voucher.

5. A method for facilitating synergistic interaction between consumers, manufacturers and retailers as claimed in claim 1 further comprising the step of:
formatting said product information for display on said handheld device.

6. A method for facilitating synergistic interaction between consumers, manufacturers and retailers comprising the steps of
interacting with a product using a handheld device provided with a camera to scan a barcode;
accessing the Global Data Synchronization Network (GDSN);
retrieving product information; and,
interacting with other consumers via social media.

7. A method for facilitating synergistic interaction between consumers, manufacturers and retailers comprising the steps of:
interacting with a product using a handheld device to scan a barcode or RFID tag of said product;
accessing a product information database;
retrieving product information; and,
interacting with other consumers via social media.

8. A method for facilitating synergistic interaction between consumers, manufacturers and retailers as claimed in claim 7 wherein said consumers are previously affiliated.

9. A method for facilitating synergistic interaction between consumers, manufacturers and retailers as claimed in claim 7 wherein said consumers are not previously affiliated but share an affinity with a product.

10. A method for facilitating synergistic interaction between consumers, manufacturers and retailers as claimed in claim 7 wherein said handheld device is a mobile telephonic device.

11. A method for facilitating synergistic interaction between consumers, manufacturers and retailers as claimed in claim 7 wherein said product information database is the Global Data Synchronization Network (GDSN).

12. A method for facilitating synergistic interaction between consumers, manufacturers and retailers as claimed in claim 7 further comprising the step of:
retrieving an item selected from the group consisting of a coupon, an electronic coupon, a printable coupon, a discount code, and discount voucher.

13. A method for facilitating synergistic interaction between consumers, manufacturers and retailers comprising the steps of:
interacting with a product using a handheld device by scanning a barcode placed on said product;
accessing a product information database;
retrieving product information; and,
facilitating charitable activities.

14. A method for facilitating synergistic interaction between consumers, manufacturers and retailers as claimed in claim 13 wherein said charitable activities further comprise facilitating charitable donations in lieu of receiving a discount.

15. A method for facilitating synergistic interaction between consumers, manufacturers and retailers as claimed in claim 13 further comprising:
interacting with other consumers via social media.

16. A method for facilitating synergistic interaction between consumers, manufacturers and retailers as claimed in claim 15 wherein said consumers are previously affiliated.

17. A method for facilitating synergistic interaction between consumers, manufacturers and retailers as claimed in claim 15 wherein said consumers are not previously affiliated but share an affinity with a product.

18. A method for facilitating synergistic interaction between consumers, manufacturers and retailers as claimed in claim 15 wherein said handheld device is a mobile telephonic device.

19. A method for facilitating synergistic interaction between consumers, manufacturers and retailers as claimed in claim 16 wherein said product information database is the Global Data Synchronization Network (GDSN).

20. A method for facilitating synergistic interaction between consumers, manufacturers and retailers as claimed in claim 14 including the step of, after retrieving product information, interacting with other consumers via social media.
